(19) United States
(12) Patent Application Publication
(10) Pub. No.: US 2005/0031743 A1
(43) Pub. Date: Feb. 10, 2005

(54) Antimicrobial casing

(76) Inventor: Carlos Longo Areso, Pamplona (ES)

Correspondence Address: SCHIFF HARDIN, LLP;PATENT DEPARTMENT, 6600 SEARS TOWER, CHICAGO, IL, 60606-6473, US

(21) Appl. No.: 10/775,834

(22) Filed: Feb. 10, 2004

(30) Foreign Application Priority Data
Feb. 10, 2003 (ES) 200300319

(51) Int. Cl. A23C 1/00

(52) U.S. Cl. 426/320

(57) ABSTRACT

The invention is directed to an application of a hop extract, hydrogenated hop extract, hop alpha acids, hop beta acids, hydrogenated hop acids, derivatives of hop acids or their resins, each separately or in combinations of two or more, on the inside surface of a cellulosic casing used in sausage manufacture to prevent the appearance and growth of gram-positive bacteria especially of the genus Listeria in these meat products. Similarly, the invention also provides a cellulosic casing for meat products coated internally with a solution of the hop derivates mentioned; and a meat product produced using this cellulosic casing. Finally, the invention provides a method to apply this solution to a meat product.

### BACKGROUND OF THE INVENTION

The present invention is directed to meat products, more specifically to sausages, and more specifically to methods to prevent the appearance and growth of bacteria in these meat products.

Bacteria of the genus Listeria and, more specifically, the bacteria Listeria monocytogenes, are among the most dangerous food-borne pathogens. According to the Centers for Disease Control (CDC), there are more hospital admissions due to infections by Listeria than by any other food-borne pathogen and it is the second cause of food-borne pathogen related mortality. It has been estimated that around 92% of patients with listeriosis (the disease caused by Listeria) require hospitalization and that 20% of these result in death.

Although listeriosis is a relatively rare disease compared with other diseases caused by other food-borne pathogens such as Salmonella or Campylobacter, it is, however, the most serious illness and the one most likely to result in death or in a severe clinical outcome. Until recently, it was thought that listeriosis only affected some population groups such as: pregnant women, children, the elderly and immunocompromised patients. Within this latter category, the highest risk patients are those with deficiencies in T-cell functionality, for example, transplant recipients and patients with cancer or AIDS. However, it appears now that 30% of cases of listeriosis occur in previously healthy individuals.

Contamination of meat products for human consumption by L. monocytogenes is one of the most alarming types of food poisoning since these products may have been widely distributed before their contamination is detected, causing large epidemic outbreaks. One example of this is the outbreak that occurred between August 1998 and February 1999, which caused 21 deaths (including six abortions) and affected 100 individuals in 22 States of the United States. The CDC identified the strain L. monocytogenes as being responsible for this epidemic outbreak, which was isolated in some frankfurter sausages and in other precooked meat products.

Frankfurter sausages are usually made by mechanically filling an artificial casing with a meat paste, the meat is separated into portions, it is coagulated by heat treatment and smoked using burning wood chips or liquid smoke. The temperature cycles normally used during sausage manufacture are sufficient to eliminate L. monocytogenes or any other contaminating microorganism. However, since the casing of the frankfurter sausages must be removed before these are packaged, the surface of the sausage is exposed for some time and can, therefore, be contaminated again.

Most frankfurter manufacturers tackle this problem by the “multiple obstacle” strategy by applying a suitable program of Hazard Analysis of Critical Control Points (HACCP) using antimicrobial additives approved for meat pastes, guaranteeing adequate cleaning of the surfaces using appropriate sterilizing agents in the cleaning products etc. Another “obstacle” in this context would be to use an “anti-listeria” casing in the frankfurter sausage manufacture as suggested by the U.S. Pat. No. 5,573,797 or, more recently, the international patent publication no. WO01/05254, in which compositions are described to coat films, casings or other packaging materials.

Briefly, this casing consists of an artificial casing made from regenerated cellulose that contains one or more substances (mainly bacteriocins) on its internal surface, capable of inhibiting growth of L. monocytogenes. These substances are in contact with the surface of the sausage during the manufacturing process and are transferred to it during processing and cooking. This transferal is an essential step since the casing is eliminated after cooking the sausage before it is packaged, thus the protective effect of this casing can be lost. If contamination by Listeria takes place after the casing has been eliminated, the antimicrobial bacteriocins exert a protective action on the surface of the sausage.

It is known that cellulosic casings transfer the desired additives during the cooking process. Cellulosic casings of this type are described, for example, in Thor et al., U.S. Pat. No. 2,521,101.

In international patent publication no. WO00/38545, an antimicrobial casing is described that transfers bacteriocins with antimicrobial properties to the surface of the sausage and in international patent publication no. WO01/05254, claims are made for casings, films, and other packaging materials coated with compositions that contain bacteriocins.

It would be advantageous to have available other packaging with different antimicrobial components of bacteriocins that have been used safely in the past in food products.

Bacteriocins are good inhibitors of L. monocytogenes and other gram-positive bacteria. However, the inventors consider that there are several reasons to avoid their use:

Firstly, a highly purified product is required to obtain highly active antimicrobial casings. The use of commercial derivatives of the fermentation of certain substrates in the presence of bacteriocin-producing bacteria (mainly lactic acid bacteria) containing small amounts of bacteriocins has given very poor or limited results (see, for example, international patent publication no. WO00/38545 and the U.S. Pat. No. 5,573,797).

Other important drawbacks are economic ones (high costs compared with the cost of the casing itself) and legal considerations (nisin is the only bacteriocin permitted as a food additive, but only in some milk products and not in meat or chicken products such as sausages).

Finally, some Listeria strains are resistant to the effects of the bacteriocin molecules. Several mutant strains with resistance against nisin have been described (see Harris, et al., “Sensitivity and resistance of Listeria monocytogenes ATCC 19115, Scott A, and UAL500 to nisin”, J Food Prot 1991, 54: 836-40; Ming & Daeschel, “Nisin resistance of food-borne bacteria and the specific resistance responses of Listeria monocytogenes Scott A”, J Food Prot 1993, 56: 944-8; Davies & Adams, “Resistance of Listeria monocytogenes to the bacteriocin nisin”, Int J Food Microbiol 1994, 21: 341-7; Song & Richard, “Antilisterial activity of three bacteriocins used at sub minimal inhibitory concentrations and cross-resistance of the survivors”, Int J Food Microbiol 1997, 36: 155-61; y Crandall & Montville, “Nisin resistance in Listeria monocytogenes ATCC 700302 is a complex phenotype”, Appl Environ Microbiol 1998, 64: 231-7). Resistances have also been described to other bacteriocins, such as mesenterocin 52, curvaticin 13 and plantaricin C19, and crossed resistances (Rekhif, et al., “Selection and properties of spontaneous mutants of Listeria monocytogenes ATCC 15313 resistant to different bacteriocins produced by lactic acid bacteria strains”, Curr Microbiol 1994, 28: 237-41). Strains resistant to bavaricin also show resistance to pediocin (Rasch & Knochel, “Variations in tolerance of Listeria monocytogenes to nisin, pediocin PA-1 and bavaricin A”, Lett Appl Microbiol 1998, 27: 275-8), and crossed resistances have also been described between nicin and other different bacteriocin groups pediocin AcH and enterococin EFS2) (see Song & Richard, 1997). One observation that could be of special relevance in meat products is that the presence of divalent cations enhances the resistance of Listeria resistant to nisin (see Crandall & Montville, 1998).

In summary, the risk of resistance to the bacteriocins is, in the inventors' opinions, the most important drawback to the use of bacteriocins in meat products. In fact, it is more important than other factors such as legal considerations, problems relating to their practical application or related to labeling, among others.

The female flowers of the hop vine (Humulus lupulus) have been historically used to give beer its characteristic aroma and bitterness. Resins can be obtained from these flowers of which the main constituents are acidic, mainly alpha acids or humulons (humulon, cohumulon and adhumulon) and beta acids or lupulons (lupulon, colupulon and adlupulon). Both types of acids exhibit antimicrobial activity although gram-negative bacteria and fungi are less sensitive to the effects of hop acids than gram-positive bacteria. (Haas, G. J. and Barsoumian, R. J., Antimicrobial Activity of Hop Resins”, Food Protec, 57: 59-61, 1994).

Essential oils, oleoresins (without solvents) and natural extracts (including distilled ones) of the hop are listed as GRAS compounds (generally recognized as safe) in the United States Federal Regulations (21 C.F.R. §182.20).

In the beer industry it has been known for some time that hop acids contained in these extracts can inhibit the growth of microorganisms responsible for altering beer such as Lactobacillus.

Hydrogenated derivatives of hop acids also present these inhibitory properties as described by Todd and Guzinski (U.S. Pat. Nos. 5,082,975 and 5,166,449), who have shown that hexahydrolupulon can be used as a selective inhibitor of the development and growth of Lactobacillus cells in the presence of yeast. Another derivative, tetrahydroisohumulon, has been used in toothpastes and other oral hygiene products to inhibit gram-positive oral bacteria responsible for plaque formation or periodontal diseases, as described in Barney, et al., U.S. Pat. No. 5,370,863.

Hop acids can also inhibit food-borne pathogens such as Listeria monocytogenes, as described in Millis and Schendel (U.S. Pat. No. 5,286,506). This patent describes that beta acids in concentrations of 6 ppm completely inhibit Listeria monocytogenes in liquid cultures and they claim the use in food products of beta acids at 6-50 ppm (based on total weight of food product) capable of inhibiting the growth of L. monocytogenes in these food products where 6-15 ppm is the preferred concentration range.

Barney, et al., in the U.S. Pat. No. 5,455,038, describes a method to inhibit Listeria using effective amounts of tetrahydroisohumulon, hexahydrocolupulon or mixtures or salts, for use in solid and liquid products, processed meats and chicken products, although they do not specifically mention cellulosic casings.

More recently, Johnson and Haas described the use of hop extracts as antimicrobial agents against Clostridium botulinum, Clostridium difficile and Helicobacter pylori (U.S. Pat. No. 6,251,461 and U.S. patent publication 2001/0014365). Barney, et al., have also suggested the use of these hop acids to prevent bacterial contamination of the yeasts usually used in the beer industry (U.S. Pat. No. 6,326,185), while Haas and Srinivasan described the use of hop extracts in an effective method to destroy undesirable protozoa (U.S. Pat. No. 6,352,726).

Finally, King and Ming (international patent publication no. WO01/06877) also describes the use of hop acids or derivatives combined with the use of one or more non-ionic surfactants, chelating agents, antioxidants and/or organic acids useful at reducing or eliminating alterations in gram-positive pathogenic bacteria of the genus Listeria in foods and other consumable goods.

### SUMMARY OF THE INVENTION

Surprisingly, the present inventors have discovered that the application of a solution of hop components without additional antimicrobial agents or surfactants other than plant extracts on the internal surface of a cellulosic casing for meat products, prevents the appearance and growth of gram-positive bacteria, especially of the genus Listeria in these meat products.

Therefore, the present invention overcomes a previous preconception in the state of the art of the technique, since the international patent publication no. WO 01/06877 cited previously mentions that the presence of hop components is not sufficient to prevent the development of Listeria in fatty foods such as meat products.

Moreover, the use of hop extracts and derivatives as antimicrobial agents in food products represents a series of additional benefits compared to the use of bacteriocins. The antimicrobial agents contained in hop extracts (or their hydrogenated derivatives) present a wider range of target microorganisms than bacteriocins. Also, hop extracts are GRAS compounds and can be economically more viable since they are simple and cheap to produce. Hop extracts can easily be enriched to have a higher beta acids contents, while it is much more expensive and complicated to concentrate bacteriocins.

On the other hand, hop beta acids and their hydrogenated derivatives are very small molecules compared with bacteriocins. They are unlikely to cause problems of allergenicity and few resistances have been described to these antimicrobial agents. In contrast, the peptidic nature of bacteriocins makes them more susceptible to allergenicity and many resistant strains of Listeria to these antimicrobial agents have been documented.

The objective of the present invention is to provide a use for hop extract, hydrogenated hop extract, hop alpha acids, hop beta acids, hydrogenated hop acids, hop acid derivatives or their resins, each separately or in combinations of two or more, to prevent the appearance and development of gram-positive bacteria on meat products. In a preferred embodiment of the invention, the use of such extracts may be applied on the internal surface of a cellulosic casing used in the manufacture of sausages to prevent the appearance and development of gram-positive bacteria, especially of the genus Listeria in these meat products.

An embodiment of the present invention also provides a cellulosic casing for meat products that is internally coated with a solution of compounds derived from the above mentioned hop and also a meat product in which this cellulosic casing has been used. Finally, an embodiment of the present invention also provides a method to apply this solution to a meat product.

### DETAILED DESCRIPTION OF THE PREFERRED EMBODIMENT

As noted previously, an embodiment of the invention provides an application of a hop extract, hydrogenated hop extract, hop alpha acids, hop beta acids, hydrogenated hop acid derivatives or their resins, each separately or in combinations of two or more of them, on the inside surface of a cellulosic casing used in meat products to prevent the appearance and development of Gram-positive bacteria, especially of the genus Listeria, in these meat products.

The extracts and compounds derived from the hop present antimicrobial properties that can be used to prevent the development of contaminating microorganisms on the surface of food products and, more specifically, on meat products. These hop components can be applied to the casing used to make sausages that is in contact with the meat product to optimize transferal of the effect of these components to the meat.

In one specific embodiment, the hop components mentioned are included in a casing to make frankfurter sausages. These hop components are transferred from the casing to the surface of the frankfurter sausage conferring their antimicrobial properties to its surface. This prevents contamination by unwanted surface microorganisms, especially by Listeria, that could cause the previously described food-borne diseases.

Similarly, another embodiment of the invention provides a cellulosic casing for meat products internally coated with a solution that contains at least one component selected from among: hop extract, hydrogenated hop extract, hop alpha acids, hop beta acids, hydrogenated hop acids, and derivatives of hop acids or their resins, characterized because the solution is free from additional antimicrobial agents other than plant extracts. Another embodiment provides a meat product that has been manufactured using the previously described cellulosic casing.

According to an embodiment of the invention, this meat product contains between 50 and 500 ppm of hop extract, hydrogenated hop extract, hop alpha acids, hop beta acids, hydrogenated hop acids, derivatives of hop acids or their resins or mixtures, each separately or two or more of them together. In another specific embodiment of the invention, this meat product contains 50 to 100 ppm of hop extract, hydrogenated hop extract, hop alpha acids, hop beta acids, hop acid derivatives or their resins or mixtures, each separately or combining together two or more of them. In one specific embodiment of the invention, this meat product contains any meat composition, either treated or not with an additional smoking process.

Another embodiment of the present invention provides a method to apply to a meat product a solution that contains at least one component selected from among: hop extract, hydrogenated hop extract, hop alpha acids, hop beta acids, hydrogenated hop acids and derivatives of hop acids or their resins and that this is devoid of antimicrobial agents other than plant extracts. This method comprises the following steps:
a) application of the solution to the inside of a cellulosic casing;
b) filling the cellulosic casing with meat paste;
c) heating and, optionally, smoking the meat product prepared in step a) so that this solution is transferred to the surface of the meat; and
d) optionally, removing the cellulosic wrapping from the meat product.

The following examples are merely illustrative of the invention and in no way limit its application.

### EXAMPLE 1

A commercial liquid extract of S. S. Steiner, Inc. that contains 10% hop beta acids was mixed with 40% glycerin. This beta acid extract usually has the following composition: 50% colupulon, 35% lupulon and 15% adlupulon, and does not contain any hydrogenated beta acid. The resulting solution was sprayed on the interior of a cellulosic casing during the gathering process; the frankfurter sausages were made with this casing and compared with frankfurters made with a standard casing. The estimated final concentration of hop beta acids was 55 ppm relative to the weight of the frankfurter sausage.

Frankfurter sausages were prepared in Viscofan installations. A normal oven treatment cycle was used without smoke treatment and the unskinned sausages were immediately transported to the laboratories. Other control sausages were skinned and weighed to estimate the mean weight to adjust the level of Lm inoculation (Listeria monocytogenes).

Inoculation was established at around 50 CFU/g. Owing to this very low level of inoculation we had to use the Most Probable Number technique (MPN). All the processes described below were carried out in sterile conditions.

After skinning the sausages and removing the casing, they were immediately inoculated with Lm at 50 CFU/g. The inoculum was carefully spread using a sterile cotton wool ball and the sausages were packed in triplicate (i.e., every three sausages received an identical treatment) in a sealed plastic bag, and were kept at 2-4° C. until the colonies were counted. This initial inoculum was also estimated by MPN techniques as explained in the following paragraph.

After the incubation period, (normally at 0, 2, 4, 7, 15, 30 and 70 days), each sausage was placed in a Stomacher bag together with 360 ml of BPW (buffered peptone water), and homogenized in a Stomacher for 30 seconds.

The liquid obtained was diluted in 1/10 series in peptone broth (the number of dilutions depends on the incubation time and the results obtained previously).

Recounts were done using the MPN method: 9 tubes of demi-Fraser broth were used; three were inoculated with 1 ml of 10-1 dilution, three with 1 ml of 10-2 dilution and three with 1 ml of 10-3 dilution. The tubes were incubated at 31±1° C. for 48 hours and the contents were spread on Palcam agar plates. The tubes in which Lm colonies were obtained were considered as positive and the MPN was estimated using positive-negative combinations in the MPN tables.

In parallel, frankfurter sausages were also prepared with the standard packaging in the Viscofam equipment, as explained previously.

After skinning the sausages and removing the casing, they were inoculated with 100 μl of Lm to obtain a final concentration of 50 CFU/g, as described previously.

After the incubation period, each sausage was homogenized in the Stomacher and the Listeria count was done as explained previously.

Table 1 shows how Listeria growth was inhibited in the frankfurter sausages made with the casing that contained hop acids compared with those made with the standard casing.

TABLE 1
Inhibition of L. monocytogenes in the sausages of Example 1 kept
at 2° C.

| | L.m. (CFU/g sausage) | | | | | |
|---|---|---|---|---|---|---|
| | Day 0 | 2 | 7 | 15 | 30 | 70 |
| Standard casing | 33 | 110 | 320 | 3600 | 20000 | 2000000 |
| Inventive casing | 33 | 18 | 34 | 400 | 580 | 87000 |

### EXAMPLE II

A hydrogenated extract of commercial hops of S. S. Steiner, Inc., which contained 10% tetraisohydrogenated hop alpha acids, was mixed with 40% glycerin. The resulting solution was sprayed on the inside of a cellulosic casing during the gathering process; frankfurter sausages were made with this casing and compared with frankfurter sausages made with a standard casing. The estimated final concentration of hydrogenated derivatives of hop acids was 55 ppm relative to the frankfurter sausage weight.

Inoculated sausages were prepared as described in Experiment 1.

Listeria growth was inhibited in the frankfurter sausages made with casing containing hop acids, compared with the frankfurter sausages made with the standard casing, as shown in Table 2.

TABLE 2
Inhibition of L. monocytogenes in the sausages in Example II
maintained at 2° C.

| | L.m. (CFU/g sausage) | | | | |
|---|---|---|---|---|---|
| | Day 0 | 2 | 7 | 15 | 34 |
| Standard casing | 109 | 170 | 66000 | 8600000 | 1400000000 |
| Inventive casing | 109 | 29 | 14000 | 240000 | 340000000 |

For the purposes of promoting an understanding of the principles of the invention, reference has been made to the preferred embodiments, and specific language has been used to describe these embodiments. However, no limitation of the scope of the invention is intended by this specific language, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects may not be described in detail. Moreover, no item or component is essential to the practice of the invention unless the element is specifically described as “essential” or “critical”. Numerous modifications and adaptations will be readily apparent to those skilled in this art without departing from the spirit and scope of the present invention.

1. A method for protecting meat products, comprising:
applying hop extract, hydrogenated hop extract, hop alpha acids, hop beta acids, hydrogenated hop acids, derivatives of hop acids or their resins, each separately or in combination of two or more, on an inside surface of a cellulosic casing used in sausage production to prevent an appearance and growth of gram-positive bacteria in such meat products.

2. The method according to claim 1, wherein the application is performed in concentrations so as to prevent the appearance and growth of bacteria of the genus Listeria in these meat products.

3. A cellulosic casing for meat products, comprising:
an internal coating comprising a solution that contains at least one of the following: hop extract, hydrogenated hop extract, hop alpha acids, hop beta acids, hydrogenated hop acids and derivatives of hop acids or their resins;
the solution comprising no additional antimicrobial agents other than plant extracts.

4. A meat product, comprising:
a cellulosic casing for meat products, comprising:
an internal coating comprising a solution that contains at least one of the following: hop extract, hydrogenated hop extract, hop alpha acids, hop beta acids, hydrogenated hop acids and derivatives of hop acids or their resins;
the solution comprising no additional antimicrobial agents other than plant extracts.

5. The meat product according to claim 4, wherein the meat product contains 50 to 500 ppm of hop extract, hydrogenated hop extract, hop alpha acids, hop beta acids, hydrogenated hop acids, derivatives of hop acids or their resins or their mixtures, separately or the combination of two or more of them.

6. The meat product according to claim 4, wherein the meat product contains 50 to 100 ppm of hop extract, hydrogenated hop extract, hop alpha acids, hop beta acids, hydrogenated hop acids, derivatives of hop acids or their resins, each separately or combinations of two or more.

7. The meat product according to claim 4 comprising any meat composition, which may or may not have been submitted to an additional smoking process.

8. A method for applying a solution to a meat product, comprising:
a) producing a solution containing at least one of the following components: hop extract, hydrogenated hop extract, hop alpha acids, hop beta acids, hydrogenated hop acids and derivatives of hop acids or their resins, which does not contain additional antimicrobial agents other than plant extracts;
b) applying the solution to an inside of a cellulosic casing;
c) filling the cellulosic casing with meat paste that is the meat product; and
d) heating the meat product so that the solution is transferred to the meat surface.

9. The method according to claim 8, further comprising removing the cellulosic casing of the meat product.

10. The method according to claim 8, wherein in step d) further comprises smoking the meat product.
